(19) United States
(12) Patent Application Publication
(10) Pub. No.: US 2015/0091802 A1
(43) Pub. Date: Apr. 2, 2015

(54) METHOD FOR CONTROLLING A MOUSE POINTER BY TOUCH PAD

(71) Applicant: TIANJIN FUNAYUANCHUANG TECHNOLOGY CO.,LTD., Tianjin (CN)

(72) Inventors: PO-SHENG SHIH, New Taipei (TW); CHIEN-YUNG CHENG, New Taipei (TW); CHUN-LUNG HUANG, New Taipei (TW); PIN-LUNG LIN, New Taipei (TW)

(21) Appl. No.: 14/456,607

(22) Filed: Aug. 11, 2014

(30) Foreign Application Priority Data
Sep. 27, 2013 (CN) 2013104476582

(51) Int. Cl. G06F 3/0354; G06F 3/041

(52) U.S. Cl. CPC G06F 3/03543; G06F 3/041
USPC 345/163; 345/173

(57) ABSTRACT

The disclosure relates to a method for controlling a mouse pointer by touch pad. S10, detecting a first touch signal. S11, judging whether the first touch signal is detected, if yes go to S12, and if no, go to S10. S12, activating a dynamic unlocking area. S13, detecting the first touch signal. S14, judging whether the first touch signal disappears, if yes, go to S15, and if no, go to S13. S15, activating a click unlocking area. S16, judging whether a second touch signal is detected within a time threshold, if yes, go to S17, and if no, go to S10. S17, judging whether the second touch signal is in the dynamic unlocking area, if yes, go to S18, and if no, go to S16. S18, judging whether the second touch point is in the click unlocking area, if yes, go to S19, if no, go to S12.

### CROSS-REFERENCE TO RELATED APPLICATIONS

This application claims priority to Chinese Patent Application No. 201310447658.2 filed on Sep. 27, 2013 in the China Intellectual Property Office, the contents of which are incorporated by reference herein.

### FIELD

The subject matter herein generally relates to a method for controlling a mouse pointer of a computer by a touch pad.

### BACKGROUND

A notebook is popular for their convenience. Notebooks typically include a touch pad for controlling the mouse pointer.

However, the touch pad of notebook is relatively smaller and usually located below the keyboard in a middle location. Therefore, the user has a limited touch space for controlling the mouse pointer. If the touch pad is enlarged, it is easy for the wrist or the palm to touch the touch pad and cause a misoperation during the user touch the touch pad.

What is needed, therefore, is to provide a method for controlling a mouse pointer by larger touch pad which can overcome the shortcomings as described above.

### BRIEF DESCRIPTION OF THE DRAWINGS

Implementations of the present technology will now be described, by way of example only, with reference to the attached figures, wherein:

FIG. 1 is a schematic view of one embodiment of a notebook.

FIG. 2 is a flow chart of one embodiment of a method for controlling a mouse pointer by a touch pad.

FIG. 3 is a schematic view of one embodiment of a dynamic unlocking area surrounding a touch point.

FIG. 4 is a schematic view of one embodiment of a dynamic unlocking area surrounding a touch point.

FIG. 5 is a schematic view of one embodiment of how the dynamic unlocking area of FIG. 4 moves according to the movement of the touch point.

FIG. 6 is a schematic view of one embodiment of a dynamic unlocking area surrounding a touch point at an edge of a touch pad.

FIG. 7 is a schematic view of one embodiment of a dynamic unlocking area surrounding a touch point at an edge of a touch pad.

FIG. 8 is a schematic view of one embodiment of a click unlocking area surrounding the position where a touch signal disappears.

FIG. 9 is a flow chart of one embodiment of a method for controlling a mouse pointer by a touch pad.

FIG. 10 is a flow chart of one embodiment of a method for controlling a mouse pointer by a touch pad.

FIG. 11 is a schematic view of one embodiment of a finger touch an area outside of a starting area.

FIG. 12 is a schematic view of one embodiment of a dynamic unlocking area surrounding a touch point when a finger touches a starting area.

FIG. 13 is a schematic view of one embodiment of how the dynamic unlocking area of FIG. 12 moves according to the movement of the touch point.

FIG. 14 is a flow chart of one embodiment of a method for controlling a mouse pointer by a touch pad.

FIG. 15 is a flow chart of one embodiment of a method for controlling a mouse pointer by a touch pad.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like. It should be noted that references to “an” or “one” embodiment in this disclosure are not necessarily to the same embodiment, and such references mean at least one.

The present disclosure relates to a method for controlling a mouse pointer of a computer by a touch pad. The computer can be a notebook, game machine, or a learning machine.

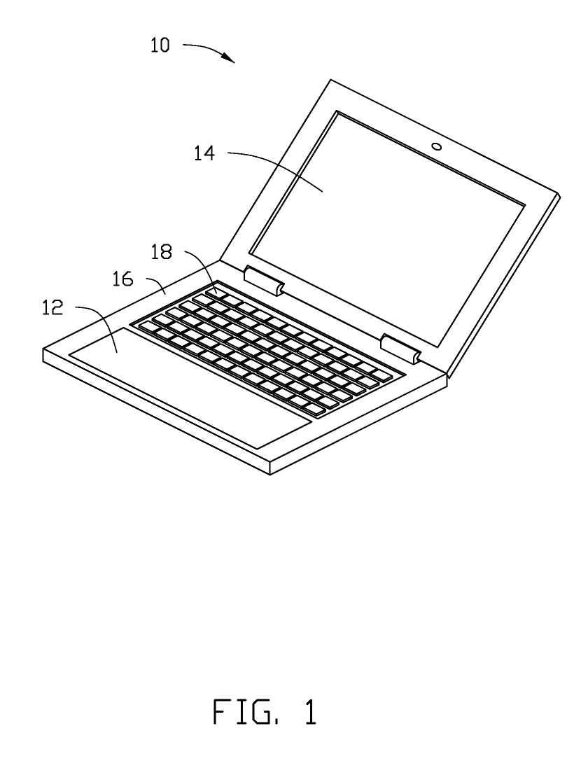

FIG. 1 illustrates a notebook 10 of one embodiment. The notebook 10 includes a main processor case 16, a display screen 14 connected to the main processor case 16, a touch pad 12 and a keyboard 18 located on a surface of the main processor case 16.

The touch pad 12 is a large touch pad. The large touch pad includes that the size of the touch pad 12 along a length direction is the same as a length of the keyboard 18. When the finger tip of the user touch the touch pad 12, it is easy for the wrist or palm of the user to touch the touch pad 12 to cause a misoperation. The size and shape of the touch pad 12 can be selected according to need. The touch pad 12 can be rectangular with a length in a range from about 25 centimeters to about 40 centimeters, and a width in a range from about 6 centimeters to about 12 centimeters. In one embodiment, the touch pad 12 is rectangular with a length about 32 centimeters and a width about 8 centimeters. A length direction of the touch pad 12 is defined as X direction, and a width direction of the touch pad 12 is defined as Y direction. The touch pad 12 extends from a first edge of the main processor case 16 to a second edge of the main processor case 16 opposite to the first edge. In some embodiments, the touch pad 12 and keyboard 18 share the same width. The touch pad 12 can be located on bottom, right side, or left side of the keyboard 18.

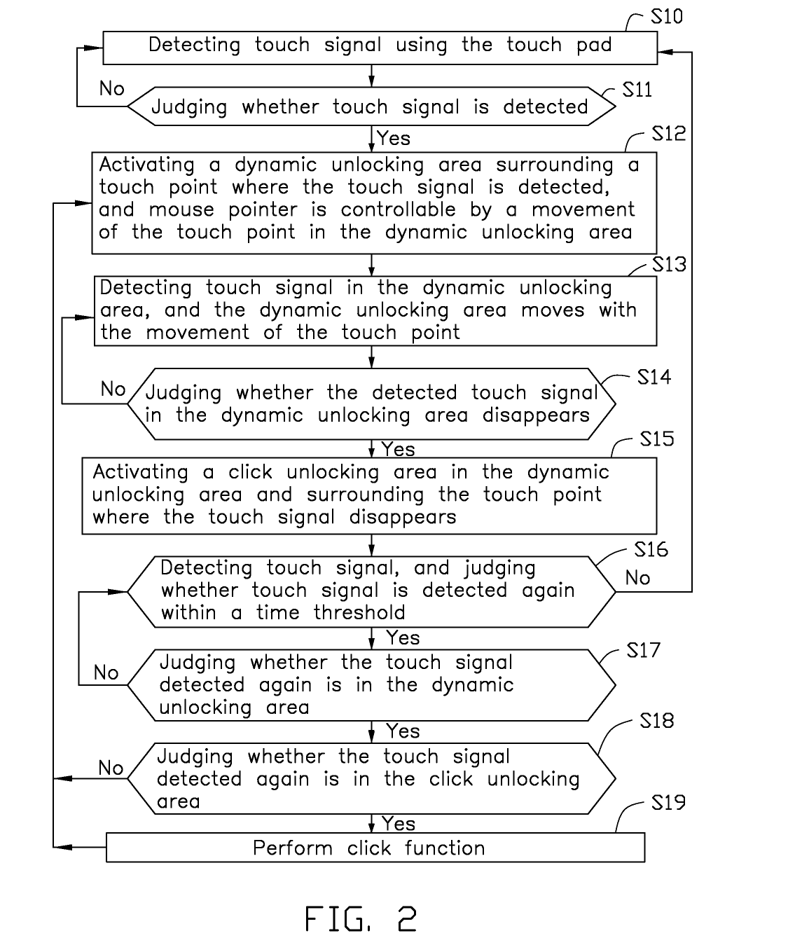

Referring to FIG. 2, a method for controlling a mouse pointer of the notebook 10 by the touch pad 12 of one embodiment is illustrated. The method includes following steps:

step (S10), detecting touch signal using the touch pad 12;

step (S11), judging whether touch signal is detected, if yes go to step (S12), and if no, go back to step (S10);

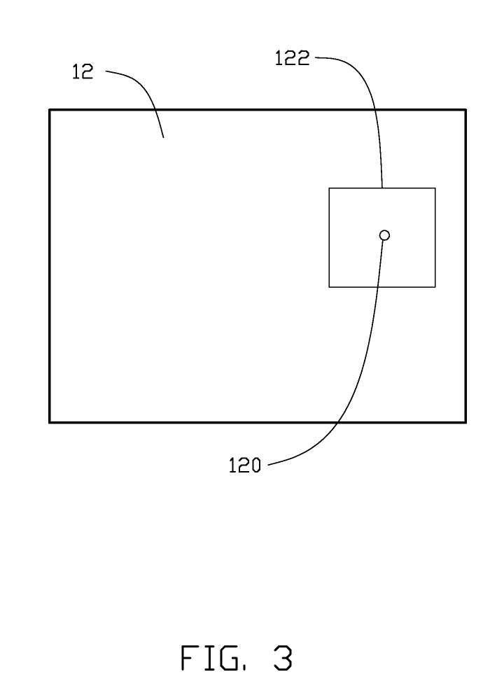

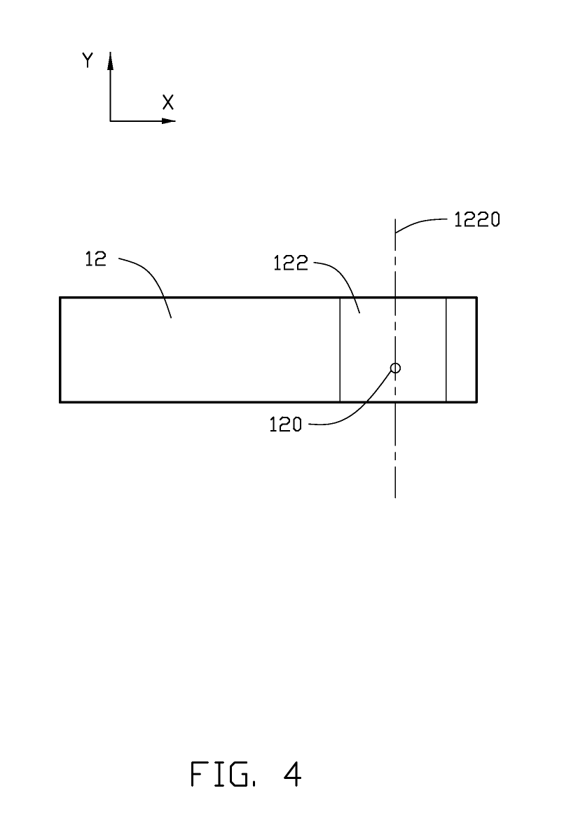

step (S12), activating a dynamic unlocking area 122 surrounding a touch point 120 where the touch signal is detected as shown in FIGS. 3-4, and mouse pointer is controllable by a movement of the touch point 120 in the dynamic unlocking area 122;

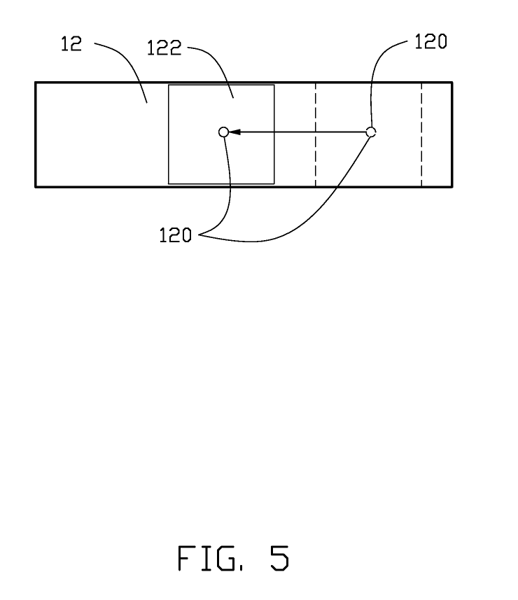

step (S13), detecting touch signal in the dynamic unlocking area 122, and the dynamic unlocking area 122 moves with the movement of the touch point 120 as shown in FIG. 5;

step (S14), judging whether the detected touch signal in the dynamic unlocking area 122 disappears, if yes, go to step (S15), and if no, go back to step (S13);

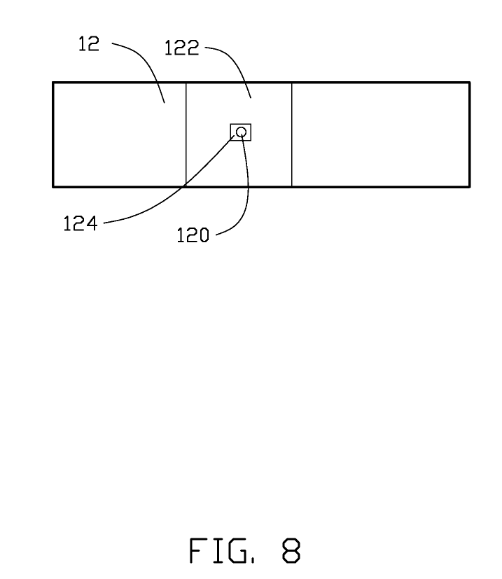

step (S15), activating a click unlocking area 124 in the dynamic unlocking area 122 and surrounding the touch point 120 where the touch signal disappears as shown in FIG. 8;

step (S16), detecting touch signal, judging whether touch signal is detected again within a time threshold, if yes, go to step (S17), and if no, go back to step (S10);

step (S17), judging whether the touch point 120 wherein touch signal is detected again is in the dynamic unlocking area 122, if yes, go to step (S18), and if no, go back to step (S16);

step (S18), judging whether the touch point 120 wherein touch signal is detected again is in the click unlocking area 124, if yes, go to step (S19), if no, go back to step (S12); and

step (S19), perform click function and then go back to step (S12).

In step (S10), the detecting method of the touch pad 12 depends on the work principle of the touch pad 12, such as capacitance-type, resistance-type, infrared ray-type. In one embodiment, the touch pad 12 is a capacitance-type that can detecting touch signal through the capacitance change on the surface of the touch pad 12.

In step (S11), the judging whether touch signal is detected is performed by software.

In step (S12), the activating the dynamic unlocking area 122 is performed by software. The activating the dynamic unlocking area 122 includes that only touch signal inside the dynamic unlocking area 122 is related to the movement of the mouse pointer, and the touch signal outside the dynamic unlocking area 122 is regarded as no touch and not related to the movement of the mouse pointer. The mouse pointer moves with the movement of the touch point in the dynamic unlocking area. Thus, even if the wrist or palm of the user touches the area outside the dynamic unlocking area 122, no misoperation will be caused.

The size and shape of the dynamic unlocking area 122 can be selected according to need. The dynamic unlocking area 122 can be a square, a rectangle or a circle surrounding the touch point 120 and having the touch point 120 as a geometric center. The dynamic unlocking area 122 can be a square, a rectangle or a circle surrounding the touch point 120 and having a straight line that pass through the touch point 120 as a symmetrical axis. As shown in FIG. 3, in one embodiment, the dynamic unlocking area 122 is a square with the touch point 120 as a geometric center. As shown in FIG. 4, in one embodiment, the dynamic unlocking area 122 is a square with the straight line 1220 that pass through touch point 120 and extend along the Y direction as a symmetrical axis. The touch point 120 can be in anywhere of the dynamic unlocking area 122 as long as the touch point 120 is in the dynamic unlocking area 122. In one embodiment, the dynamic unlocking area 122 is a square with a side length of about 8 centimeters. Thus, the dynamic unlocking area 122 is one fourth of the touch pad 12.

In step (S13), the dynamic unlocking area 122 moves with the movement of the touch point 120 in real time. The dynamic unlocking area 122 is formed according to the position of the touch point 120. As shown in FIG. 5, when the touch point 120 moves along the arrow, the dynamic unlocking area 122 also move along the arrow.

When the dynamic unlocking area 122 is a square with the touch point 120 as a geometric center as shown in FIG. 3, if the touch point 120 moves along any direction, the dynamic unlocking area 122 will move as the movement of the touch point 120. When the dynamic unlocking area 122 is a square with the straight line 1220 that pass through touch point 120 and extend along the Y direction as a symmetrical axis as shown in FIG. 4, if the touch point 120 moves along the X direction, the dynamic unlocking area 122 will move as the movement of the touch point 120, and if the touch point 120 moves along the Y direction, the dynamic unlocking area 122 will not move as the movement of the touch point 120.

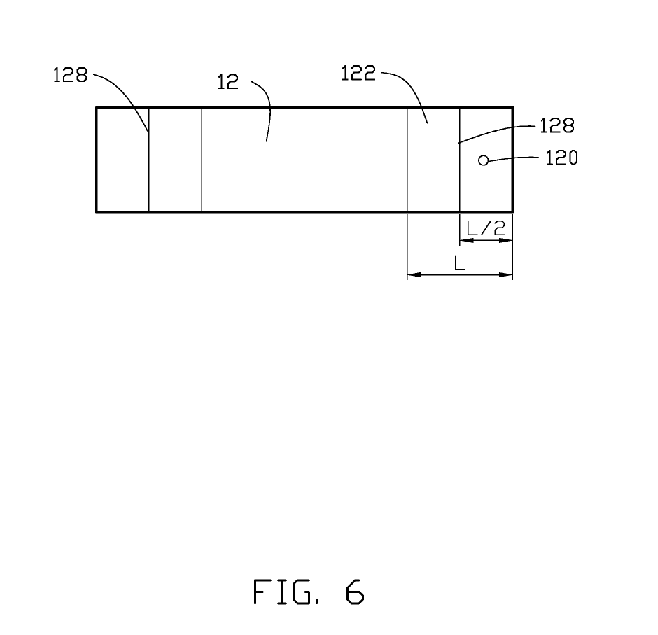

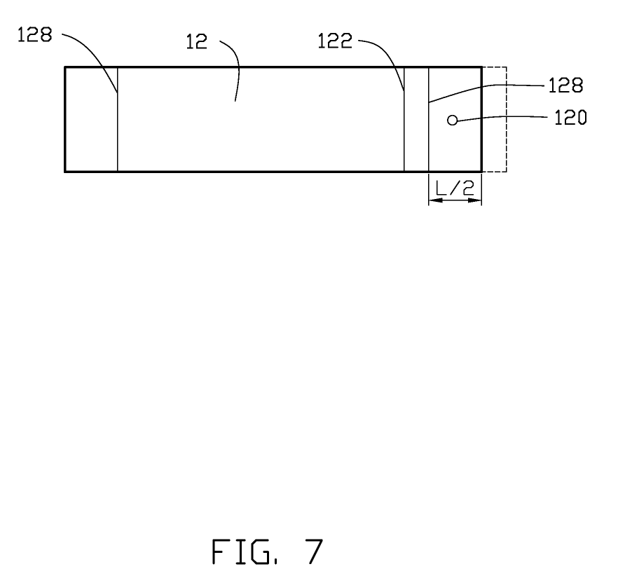

As shown in FIGS. 6-7, when the touch point 120 moves to an area adjacent to the width edge side of the touch pad 12, and the distance between the touch point 120 and the width edge side is smaller than half of the side of the dynamic unlocking area 122 along X direction, the dynamic unlocking area 122 cannot be defined as a square with the straight line 1220 that pass through touch point 120 and extend along the Y direction as a symmetrical axis. Two solutions are provided in this disclosure. In one embodiment, as shown in FIG. 6, a boundary 128 is defined, and the boundary 128 is a straight line parallel with the width edge side of the touch pad 12 and spaced from the width edge side of the touch pad 12 with a distance of L/2, wherein L is the side length of the dynamic unlocking area 122 along X direction. When the touch point 120 moves to the area between the boundary 128 and the width edge side of the touch pad 12, the dynamic unlocking area 122 will always be defined as the square with the boundary 128 as a symmetrical axis. That is, when the touch point 120 moves in the area between the boundary 128 and the width edge side of the touch pad 12, the dynamic unlocking area 122 will not changed. In one embodiment, as shown in FIG. 7, when the touch point 120 moves to the area between the boundary 128 and the width edge side of the touch pad 12, part of the dynamic unlocking area 122 is defined outside of the touch pad 12, and the real dynamic unlocking area 122 on the touch pad 12 will be decreased as the touch point 120 closes to the width edge side of the touch pad 12. The shorter from the touch point 120 to the width edge side of the touch pad 12, the narrower the real dynamic unlocking area 122 along X direction. When the touch point 120 is on the width edge side of the touch pad 12, the real dynamic unlocking area 122 is half of the entire dynamic unlocking area 122.

In step (S14), the judging whether the detected touch signal in the dynamic unlocking area 122 disappears is performed by software.

In step (S15), the activating a click unlocking area 124 includes defining an area where when the user clicks or double clicks, the notebook 10 will perform a corresponding function. The click unlocking area 124 is smaller than the dynamic unlocking area 122. The size and shape of the click unlocking area 124 can be selected according to need. The click unlocking area 124 can be a square or circle having the touch point 120 as a geometric center. In one embodiment, the click unlocking area 124 is a square with a side length of about 2 centimeters.

In step (S16), the judging whether touch signal is detected again within a time threshold is performed by software. The dynamic unlocking area 122 will be kept for a certain time as long as the time threshold after the touch signal disappears. The time threshold can be an experiential time, such as from about 2 seconds to about 5 seconds. In one embodiment, the time threshold is 2 second. After the finger is move away from the touch pad 12, the dynamic unlocking area 122 will be kept for 2 seconds.

In step (S17), the judging whether the touch point 120 wherein touch signal is detected again is in the dynamic unlocking area 122 is performed by software. If the touch point 120 wherein touch signal is detected again is not in the dynamic unlocking area 122, regarding as no touch and go back to step (S16). If go back to step (S16), detecting touch signal within a time threshold again.

In step (S18), the judging whether the touch point 120 wherein touch signal is detected again is in the click unlocking area 124 is performed by software. If go back to step (S12), the user can start a new operation of mouse pointer or click.

In step (S19), the click function can be a single click or a double click.

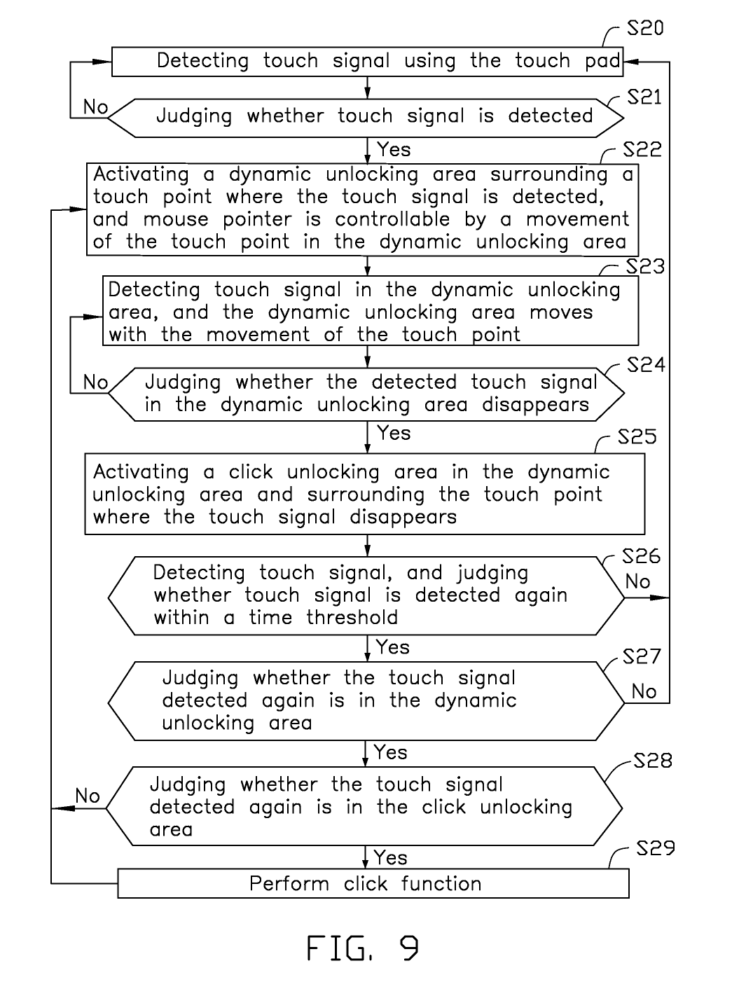

Referring to FIG. 9, a method for controlling a mouse pointer of the notebook 10 by the touch pad 12 of one embodiment is illustrated. The method includes following steps:

step (S20), detecting touch signal using the touch pad 12; step (S21), judging whether touch signal is detected, if yes go to step (S22), and if no, go back to step (S20);

step (S22), activating a dynamic unlocking area 122 surrounding a touch point 120 where the touch signal is detected as shown in FIGS. 3-4, and mouse pointer is controllable by a movement of the touch point 120 in the dynamic unlocking area 122;

step (S23), detecting touch signal in the dynamic unlocking area 122, and the dynamic unlocking area 122 moves with the movement of the touch point 120 as shown in FIG. 5;

step (S24), judging whether the detected touch signal in the dynamic unlocking area 122 disappears, if yes, go to step (S25), and if no, go back to step (S23);

step (S25), activating a click unlocking area 124 in the dynamic unlocking area 122 and surrounding the touch point 120 where the touch signal disappears;

step (S26), detecting touch signal, judging whether touch signal is detected again within a time threshold, if yes, go to step (S27), and if no, go back to step (S20);

step (S27), judging whether the touch signal detected again is in the dynamic unlocking area 122, if yes, go to step (S28), and if no, go back to step (S20);

step (S28), judging whether the touch signal detected again is in the click unlocking area 124, if yes, go to step (S29), if no, go back to step (S22); and

step (S29), perform click function and then go back to step (S22).

The method of FIG. 9 is similar to the method of FIG. 1 except that, in step (S27), when no touch signal is detected again, go back to step (S20) rather than step (S26).

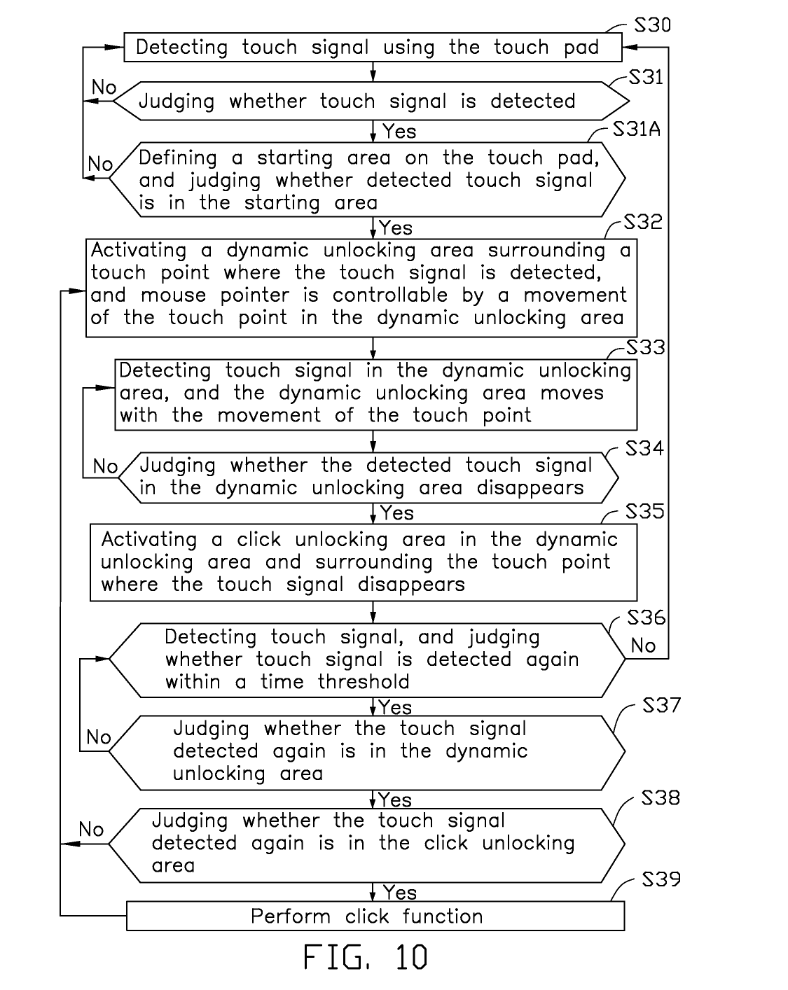

Referring to FIGS. 10-13, a method for controlling a mouse pointer of the notebook 10 by the touch pad 12 of one embodiment is illustrated. The method includes following steps:

step (S30), detecting touch signal using the touch pad 12;

step (S31), judging whether touch signal is detected, if yes go to step (S31A), and if no, go back to step (S30);

step (S31A), defining a starting area 126 on the touch pad 12, and judging whether detected touch signal is in the starting area 126, if yes go to step (S32), and if no, go back to step (S30);

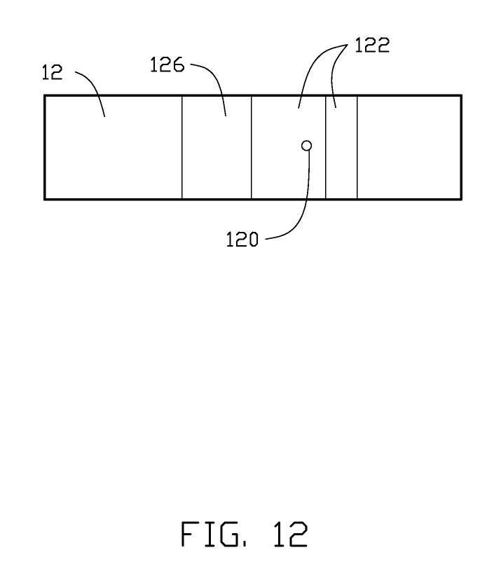

step (S32), activating a dynamic unlocking area 122 surrounding a touch point 120 where the touch signal is detected as shown in FIG. 12, and mouse pointer is controllable by a movement of the touch point 120 in the dynamic unlocking area 122;

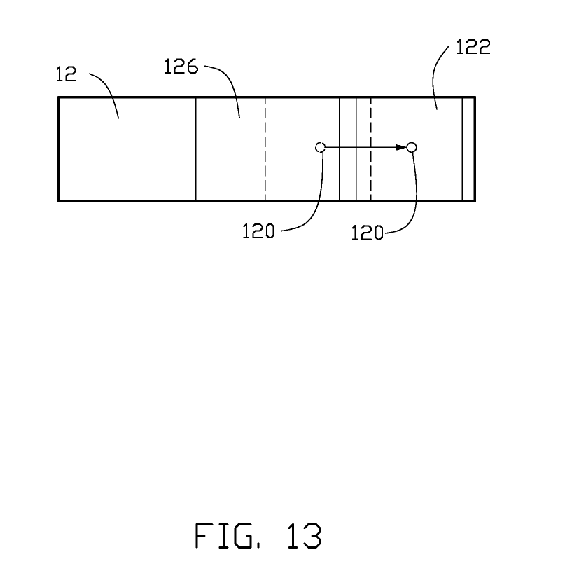

step (S33), detecting touch signal in the dynamic unlocking area 122, and the dynamic unlocking area 122 moves with the movement of the touch point 120 as shown in FIG. 13;

step (S34), judging whether the detected touch signal in the dynamic unlocking area 122 disappears, if yes, go to step (S35), and if no, go back to step (S33);

step (S35), activating a click unlocking area 124 in the dynamic unlocking area 122 and surrounding the touch point 120 where the touch signal disappears;

step (S36), detecting touch signal, judging whether touch signal is detected again within a time threshold, if yes, go to step (S37), and if no, go back to step (S30);

step (S37), judging whether the touch signal detected again is in the dynamic unlocking area 122, if yes, go to step (S38), and if no, go back to step (S36);

step (S38), judging whether the touch signal detected again is in the click unlocking area 124, if yes, go to step (S39), if no, go back to step (S32); and

step (S39), perform click function and then go back to step (S32).

The method of FIG. 10 is similar to the method of FIG. 1 except that further comprises a step (S31A) between steps (S31) and (S32).

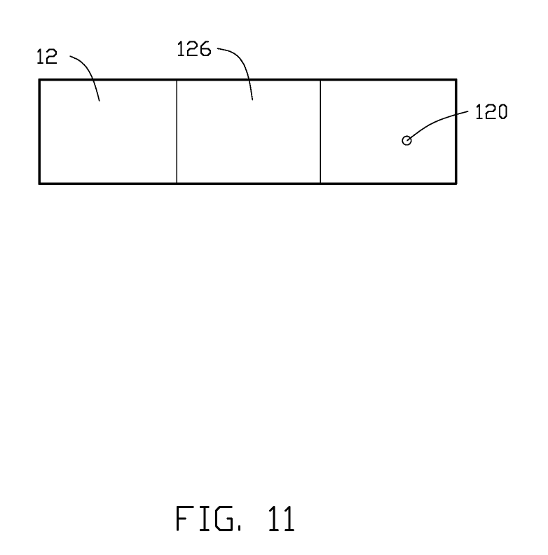

In step (S31A), if the touch signal detected is not in the starting area 126, regarding as no touch and go back to step (S30). The size, location and shape of the starting area 126 can be selected according to need. The starting area 126 can be a center area of the touch pad 12. In one embodiment, the starting area 126 is a ⅓ center area of the touch pad 12 along X direction as shown in FIG. 11. When the finger touches the area outside of the starting area 126 as shown in FIG. 11, no dynamic unlocking area 122 will be activated. The ⅓ center area of the touch pad 12 is not easy to be touched by the wrist or the palm, and the other area is easy to be touched by the wrist or the palm when user operates the keyboard 18. Thus, it can avoid the misoperation of mouse pointer when user operates the keyboard 18. When user want to control the mouse pointer by the touch pad 12, he can touch the touch pad 12 from the starting area 126.

In step (S33), the dynamic unlocking area 122 moves out of the starting area 126 as the touch point 120 moves out of the starting area 126 as shown in FIG. 13.

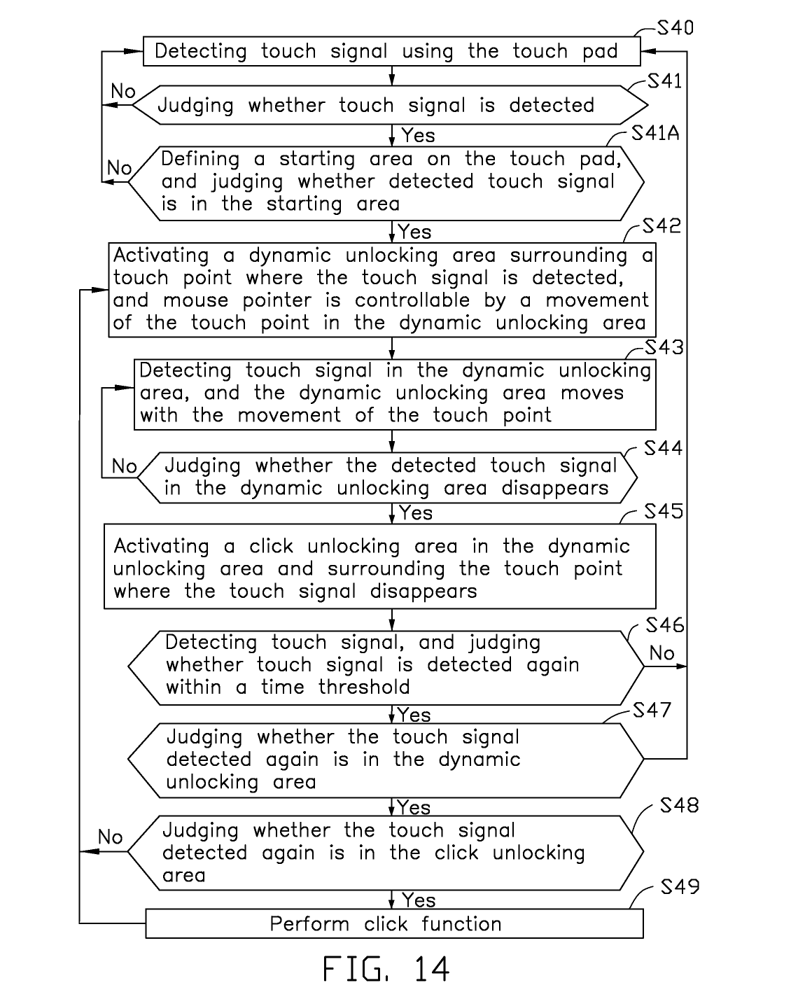

Referring to FIG. 14, a method for controlling a mouse pointer of the notebook 10 by the touch pad 12 of one embodiment is illustrated. The method includes following steps:

step (S40), detecting touch signal using the touch pad 12;

step (S41), judging whether touch signal is detected, if yes go to step (S41A), and if no, go back to step (S40);

step (S41A), defining a starting area 126 on the touch pad 12, and judging whether detected touch signal is in the starting area 126, if yes go to step (S42), and if no, go back to step (S40);

step (S42), activating a dynamic unlocking area 122 surrounding a touch point 120 where the touch signal is detected as shown in FIG. 12, and mouse pointer is controllable by a movement of the touch point 120 in the dynamic unlocking area 122;

step (S43), detecting touch signal in the dynamic unlocking area 122, and the dynamic unlocking area 122 moves with the movement of the touch point 120 as shown in FIG. 13;

step (S44), judging whether the detected touch signal in the dynamic unlocking area 122 disappears, if yes, go to step (S45), and if no, go back to step (S43);

step (S45), activating a click unlocking area 124 in the dynamic unlocking area 122 and surrounding the touch point 120 where the touch signal disappears;

step (S46), detecting touch signal, judging whether touch signal is detected again within a time threshold, if yes, go to step (S47), and if no, go back to step (S40);

step (S47), judging whether the touch signal detected again is in the dynamic unlocking area 122, if yes, go to step (S48), and if no, go back to step (S40);

step (S48), judging whether the touch signal detected again is in the click unlocking area 124, if yes, go to step (S49), if no, go back to step (S42); and

step (S49), perform click function and then go back to step (S42).

The method of FIG. 14 is similar to the method of FIG. 10 except that, in step (S47), when no touch signal is detected again, go back to step (S40) rather than step (S46).

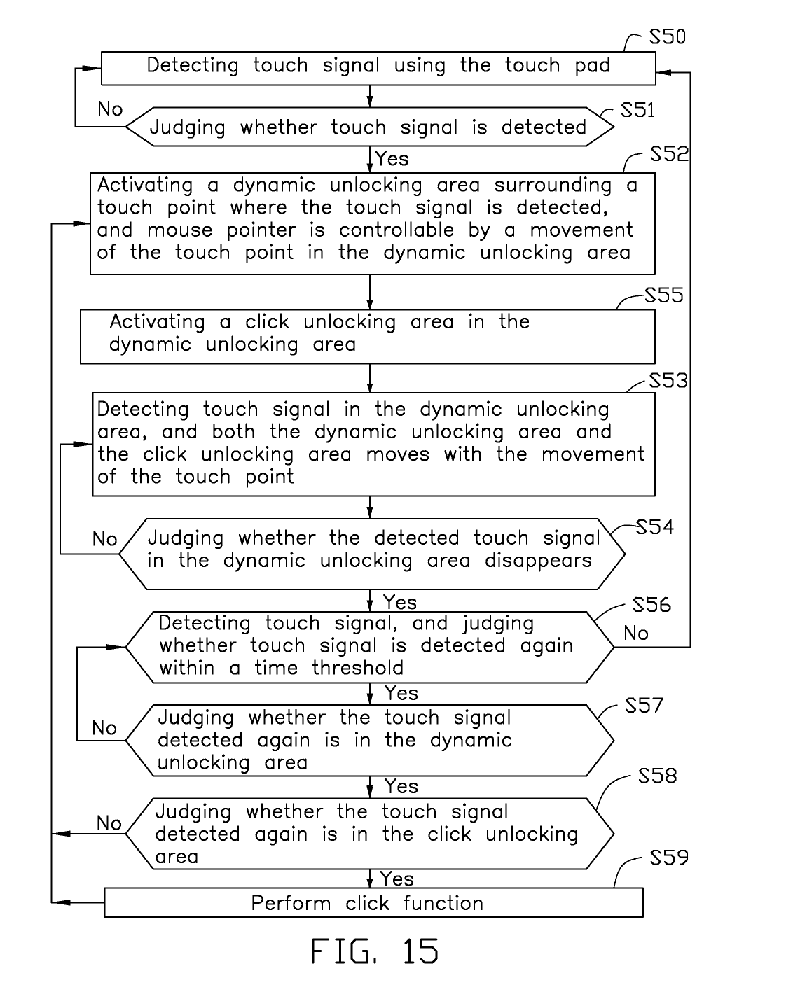

Referring to FIG. 15, a method for controlling a mouse pointer of the notebook 10 by the touch pad 12 of one embodiment is illustrated. The method includes following steps:

step (S50), detecting touch signal using the touch pad 12;

step (S51), judging whether touch signal is detected, if yes go to step (S52), and if no, go back to step (S50);

step (S52), activating a dynamic unlocking area 122 surrounding a touch point 120 where the touch signal is detected, and mouse pointer is controllable by a movement of the touch point 120 in the dynamic unlocking area 122;

step (S55), activating a click unlocking area 124 in the dynamic unlocking area 122 and surrounding the touch point 120;

step (S53), detecting touch signal in the dynamic unlocking area 122, and both the dynamic unlocking area 122 and the click unlocking area 124 moves with the movement of the touch point 120;

step (S54), judging whether the detected touch signal in the dynamic unlocking area 122 disappears, if yes, go to step (S56), and if no, go back to step (S53);

step (S56), detecting touch signal, judging whether touch signal is detected again within a time threshold, if yes, go to step (S57), and if no, go back to step (S50);

step (S57), judging whether the touch signal detected again is in the dynamic unlocking area 122, if yes, go to step (S58), and if no, go back to step (S56);

step (S58), judging whether the touch signal detected again is in the click unlocking area 124, if yes, go to step (S59), if no, go back to step (S52); and

step (S59), perform click function and then go back to step (S52).

The method of FIG. 15 is similar to the method of FIG. 2 except that, step (S55) is performed before step (S53) and after step (S52); in step (S53), both the dynamic unlocking area 122 and the click unlocking area 124 moves with the movement of the touch point 120; and in step (S54), if yes, go to step (S56) directly.

Furthermore, in one embodiment, step (S55) can also be performed before step (S52) and after step (S51); in step (S55), the click unlocking area 124 surrounds the touch point 120 where the touch signal is detected; and in step (S52), the dynamic unlocking area 122 surrounds the click unlocking area 124. In one embodiment, step (S55) can also be performed before step (S54) and after step (S53).

The embodiments shown and described above are only examples. Even though numerous characteristics and advantages of the present technology have been set forth in the forego description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

Depending on the embodiment, certain of the steps of methods described may be removed, others may be added, and the sequence of steps may be altered. The description and the claims drawn to a method may include some indication in reference to certain steps. However, the indication used is only to be viewed for identification purposes and not as a suggestion as to an order for the steps.

What is claimed is:

1. A method for controlling a mouse pointer by a touch pad, the method comprises the following steps:
step (S10), detecting a first touch signal using the touch pad;
step (S11), judging whether the first touch signal is detected;
step (S12), activating a dynamic unlocking area surrounding a first position where the first touch signal is detected, and mouse pointer is controllable by a movement of the first touch signal in the dynamic unlocking area;
step (S13), detecting the movement of the first touch signal, and the dynamic unlocking area moves with the movement of the first touch signal;
step (S14), judging whether the first touch signal disappears;
step (S15), activating a click unlocking area;
step (S16), detecting a second touch signal, judging whether the second touch signal is detected within a time threshold;
step (S17), judging whether the second touch signal is in the dynamic unlocking area;
step (S18), judging whether the second touch point is in the click unlocking area; and
step (S19), perform click function and then go to step (S12).

2. The method of claim 1, wherein in step (S11), if yes go to step (S12), and if no, go to step (S10).

3. The method of claim 1, wherein step (S15) is performed before step (S12); the click unlocking area surrounds the first touch signal; in step (S12), the dynamic unlocking area surrounds the click unlocking area; and in step (S13), the click unlocking area moves with the movement of the first touch signal.

4. The method of claim 1, wherein step (S15) is performed after step (S12); the click unlocking area is in the dynamic unlocking area and surrounds the first touch signal; and in step (S13), the click unlocking area moves with the movement of the first touch signal.

5. The method of claim 1, wherein step (S15) is performed after step (S14); the click unlocking area is in the dynamic unlocking area and surrounds a second position where the first touch signal disappears; and in step (S14), if yes, go to step (S15), and if no, go to step (S13).

6. The method of claim 1, wherein in step (S16), if yes, go to step (S17), and if no, go to step (S10).

7. The method of claim 1, wherein in step (S17), if yes, go to step (S18), and if no, go to step (S16).

8. The method of claim 1, wherein in step (S17), if yes, go to step (S18), and if no, go to step (S10).

9. The method of claim 1, wherein in step (S18), if yes, go to step (S19), if no, go to step (S12).

10. The method of claim 1, wherein only the first touch signal inside the dynamic unlocking area is related to a movement of the mouse pointer; and the mouse pointer moves with the movement of the first touch signal in the dynamic unlocking area.

11. The method of claim 1, wherein the dynamic unlocking area is a square, a rectangle or a circle surrounding the first position and having the first position as a geometric center.

12. The method of claim 1, wherein the dynamic unlocking area is a square, a rectangle or a circle surrounding the first position and having a straight line that pass through the first position as a symmetrical axis.

13. The method of claim 12, wherein the touch pad is a rectangle with a length side defined as an X direction and a width side defined as a Y direction; the straight line is parallel with the Y direction; a boundary is defined, and the boundary is a straight line parallel with a width edge side of the touch pad and spaced from the width edge side of the touch pad with a distance of L/2, wherein L is the side length of the dynamic unlocking area along the X direction; and when the first touch signal moves to an area between the boundary and the width edge side of the touch pad, the dynamic unlocking area will always be the same.

14. The method of claim 12, wherein the touch pad is a rectangle with a length side defined as an X direction and a width side defined as a Y direction; the straight line is parallel with the Y direction; a boundary is defined, and the boundary is a straight line parallel with a width edge side of the touch pad and spaced from the width edge side of the touch pad with a distance of L/2, wherein L is the side length of the dynamic unlocking area along the X direction; and when the first touch signal moves to an area between the boundary and the width edge side of the touch pad, the dynamic unlocking area will gradually decrease as the first touch signal closes to the width edge side of the touch pad.

15. The method of claim 1, wherein the click unlocking area is a square or circle having the first touch signal or a second position where the first touch signal disappears as a geometric center; and the time threshold is in a range from about 2 seconds to about 5 seconds.

16. The method of claim 15, wherein the click unlocking area is a square with a side length of about 2 centimeters; and the time threshold is about 2 seconds.

17. A method for controlling a mouse pointer by a touch pad, the method comprises the following steps:
step (S10), detecting a first touch signal using the touch pad;
step (S11), judging whether the first touch signal is detected;
step (S12), activating a dynamic unlocking area surrounding a first position where the first touch signal is detected, and mouse pointer is controllable by a movement of the first touch signal in the dynamic unlocking area;
step (S13), detecting the movement of the first touch signal, and the dynamic unlocking area moves with the movement of the first touch signal;
step (S14), judging whether the first touch signal disappears;
step (S15), activating a click unlocking area, in the dynamic unlocking area, and surrounding a second position where the first touch signal disappears;
step (S16), detecting a second touch signal, judging whether the second touch signal is detected within a time threshold;
step (S17), judging whether the second touch signal is in the dynamic unlocking area;
step (S18), judging whether the second touch point is in the click unlocking area; and
step (S19), perform click function and then go to step (S12);
wherein:
in step (S11), if yes go to step (S12), and if no, go to step (S10);
in step (S14), if yes, go to step (S15), and if no, go to step (S13);
in step (S16), if yes, go to step (S17), and if no, go to step (S10);
in step (S17), if yes, go to step (S18), and if no, go to step (S16); and
in step (S18), if yes, go to step (S19), if no, go to step (S12).

18. The method of claim 17, further comprises a step (S11A) of defining a starting area on the touch pad, and judging whether the first touch signal is in the starting area, wherein if yes go to step (S12), and if no, go to step (S10).

19. A method for controlling a mouse pointer by a touch pad, the method comprises the following steps:
step (S10), detecting a first touch signal using the touch pad;
step (S11), judging whether the first touch signal is detected;
step (S12), activating a dynamic unlocking area surrounding a first position where the first touch signal is detected, and mouse pointer is controllable by a movement of the first touch signal in the dynamic unlocking area;
step (S13), detecting the movement of the first touch signal, and the dynamic unlocking area moves with the movement of the first touch signal;
step (S14), judging whether the first touch signal disappears;
step (S15), activating a click unlocking area, in the dynamic unlocking area, and surrounding a second position where the first touch signal disappears;
step (S16), detecting a second touch signal, judging whether the second touch signal is detected within a time threshold;
step (S17), judging whether the second touch signal is in the dynamic unlocking area;
step (S18), judging whether the second touch point is in the click unlocking area; and
step (S19), perform click function and then go to step (S12);
wherein:
in step (S11), if yes go to step (S12), and if no, go to step (S10);
in step (S14), if yes, go to step (S15), and if no, go to step (S13);
in step (S16), if yes, go to step (S17), and if no, go to step (S10);
in step (S17), if yes, go to step (S18), and if no, go to step (S10); and
in step (S18), if yes, go to step (S19), if no, go to step (S12).

20. The method of claim 19, further comprises a step (S11A) of defining a starting area on the touch pad, and judging whether the first touch signal is in the starting area, wherein if yes go to step (S12), and if no, go to step (S10).
